(19) United States
(12) Patent Application Publication
(10) Pub. No.: US 2020/0387246 A1
(43) Pub. Date: Dec. 10, 2020

(54) SYSTEMS AND METHODS FOR PARTICLE JAMMING HAPTIC FEEDBACK

(71) Applicant: Immersion Corporation, San Jose, CA (US)

(72) Inventors: Vahid Khoshkava, Laval, CA (US); Juan Manuel Cruz-Hernandez, Westmount (CA)

(73) Assignee: Immersion Corporation, San Jose, CA (US)

(21) Appl. No.: 16/436,334

(22) Filed: Jun. 10, 2019

(51) Int. Cl. G06F 3/041; G06F 3/01

(52) U.S. Cl. CPC G06F 3/041; G06F 3/04886; G06F 3/016

(57) ABSTRACT

One illustrative system described herein includes at least one cell, a plurality of particles disposed in the at least one cell, a first actuator configured to change a pressure of the at least one cell, a valve configured to control the pressure of the at least one cell, and a processor communicatively coupled to the first actuator and the valve and configured to receive an activation signal, determine a pressure change value for the at least one cell based in part on the activation signal, transmit a first pressure change signal to the first actuator to cause the first actuator to alter a stiffness of the at least one cell based in part on the pressure change value, and transmit a second pressure change signal to the valve to cause the valve to alter the stiffness of the at least one cell based on the pressure change value.

### FIELD OF THE INVENTION

The present application relates to the field of user interface devices. More specifically, the present application relates to providing haptic feedback using particle jamming.

### BACKGROUND

Haptic-enabled devices and environments have become increasingly popular. Such devices and environments are able to provide a more immersive user experience. Many modern user interface devices provide vibrotactile haptic feedback as the user interacts with the device. There is a need to provide a kinesthetic feedback for a user interface that is pleasant and meaningful.

### SUMMARY

Embodiments of the present disclosure comprise systems and methods for providing haptic feedback using particle jamming. In one embodiment, a system comprises at least one cell; a plurality of particles disposed in the at least one cell; a first actuator configured to change a pressure of the at least one cell; a valve configured to control the pressure of the at least one cell; and a processor communicatively coupled to the first actuator and the valve, the processor configured to: receive an activation signal; determine a pressure change value for the at least one cell based in part on the activation signal; transmit a first pressure change signal to the first actuator to cause the first actuator to alter a stiffness of the at least one cell based in part on the pressure change value; and transmit a second pressure change signal to the valve to cause the valve to alter the stiffness of the at least one cell based on the pressure change value.

In another embodiment, a method comprises receiving an activation signal, determining, based in part on the activation signal, a pressure change value for at least one cell comprising a plurality of particles disposed in the at least one cell, transmitting a first pressure change signal to a first actuator to cause the first actuator to alter a stiffness of the at least one cell based in part on the pressure change value, and transmitting a second pressure change signal to a valve to cause the valve to alter the stiffness of the at least one cell based on the pressure change value.

In yet another embodiment, a non-transitory computer readable medium may comprise program code, which when executed by a processor is configured to perform such methods.

These illustrative embodiments are mentioned not to limit or define the limits of the present subject matter, but to provide examples to aid understanding thereof Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 shows an illustrative system for providing haptic feedback using particle jamming.

FIG. 1B shows an illustrative haptic output device for providing haptic feedback using particle jamming.

FIG. 2 shows an illustrative cell for providing haptic feedback using particle jamming.

FIG. 3 shows another illustrative system for providing haptic feedback using particle jamming.

FIG. 4 shows another illustrative system for providing haptic feedback using particle jamming.

FIG. 5 is a flow chart of method steps for one example embodiment for providing haptic feedback using particle jamming.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used in another embodiment to yield a still further embodiment. Thus, it is intended that this disclosure include modifications and variations as come within the scope of the appended claims and their equivalents.

### Illustrative Example of Providing Haptic Feedback Using Particle Jamming

This illustrative embodiment of the present disclosure comprises a system for providing haptic feedback using particle jamming. The system comprises a plurality of fine particles disposed in at least one cell, a first actuator, a valve, and a processor in communication with the first actuator and the valve. The illustrative embodiment may include an electronic device, such as a tablet, e-reader, mobile phone, computer such as a laptop or desktop computer, wearable device, or interface for Virtual Reality (“VR”) or Augmented Reality (“AR”), to which the haptic feedback is output. Further, the illustrative system may be incorporated into a conventional interface device, e.g., one or more of a touchscreen, mouse, joystick, multifunction controller, etc.

In one illustrative embodiment, at least one cell is made from a rubber and filled with finely ground coffee beans. Using the processor to control the first actuator and the valve, the amount of air occupying at least one cell may be controlled so that the pressure, and thus the stiffness, of at least one cell is adjusted. For example, the first actuator, e.g., a vacuum pump, may create a vacuum in at least one cell, and the valve may be used to maintain that vacuum. Creating and maintaining a vacuum in at least one cell causes each particle of the finely ground coffee beans to jam together so that at least one cell becomes a hard structure.

In one illustrative embodiment, at least one cell is incorporated into a wearable device such as a smart watch. At least one cell may be part of a plurality of cells that form an array and may each be controlled individually to provide a user with kinesthetic feedback. When the user is interacting with the smart watch, the plurality of cells may be in a soft state, i.e., no vacuum has been created in any of the cells by the vacuum pump. The processor may activate the first actuator and the valve to create and maintain a vacuum in some of the cells in order to convey information to the user. The cells that have been stiffened due to the creation of a vacuum in those cells may form a letter or a word to indicate receipt of a communication or to provide the user with a notification. For example, the stiffened cells may form a “T” to indicate that a text message was received or an “E” to indicate that an e-mail was received. The valve may be used to keep the stiffened cells in this hard state. So after a vacuum has been created in the cells by the vacuum pump, the valve may maintain the vacuum in the cells for a set interval of time or until the user provides an input.

In another illustrative embodiment, at least one cell is incorporated into a wearable item such as a glove, a shirt, pants, socks, hat, headband, wristband, shoes, etc. to form a smart textile. Again, at least one cell may be part of a plurality of cells that are each controlled individually by an actuator and a valve in order to provide the user with kinesthetic feedback. The processor may activate the actuator and the valve to cause the cells to have a variable stiffness compared to each other so that the actuated cells may create particular spatial patterns or limit the movement of a wearer. For example, if the user is playing a game in an AR or VR environment and the user's hand (or the hand of the user's avatar) is injured, frozen, etc. and thus unusable in the game, then the vacuum pump may create a vacuum in the cells of the glove on that hand so that the cells are stiffened, and the user's hand is immobilized.

By using a plurality of small, individually controllable cells, the response time to create a vacuum in each cell is decreased significantly. This may allow for more accurate kinesthetic feedback. Additionally, the array of individually controllable cells allows for a greater variety of patterns and kinesthetic feedback to be created using the cells so that they may provide more meaningful feedback in the relevant context.

This illustrative example is given to introduce the reader to the general subject matter discussed herein and the disclosure is not limited to this example. The following sections describe various additional non-limiting examples of the present disclosure.

### Illustrative Systems for Providing Haptic Feedback Using Particle Jamming

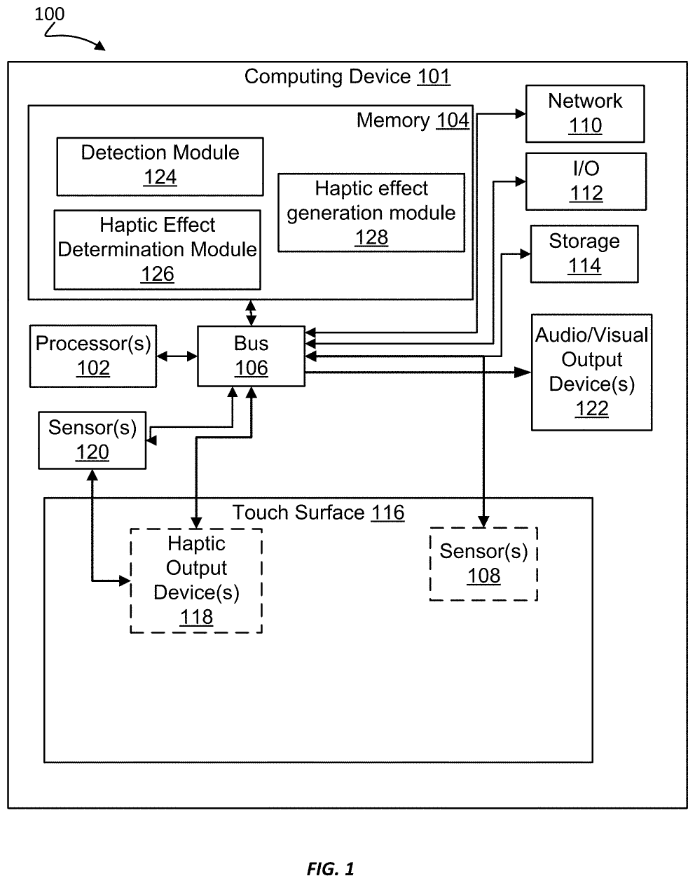

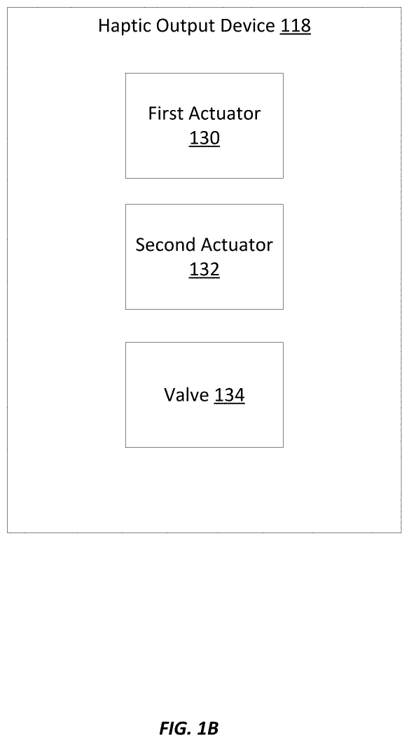

FIG. 1 shows an illustrative system 100 for providing haptic feedback using particle jamming. Particularly, in this example, system 100 comprises a computing device 101 having a processor 102 interfaced with other hardware via bus 106. A memory 104, which can comprise any suitable tangible (and non-transitory) computer-readable medium such as RAM, ROM, EEPROM, or the like, embodies program components that configure operation of the computing device 101. In this example, computing device 101 further includes one or more network interface devices 110, input/output (I/O) interface components 112, and additional storage 114.

Network device 110 can represent one or more of any components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network(s)).

I/O components 112 may be used to facilitate connection to devices such as one or more displays, such as VR and AR headsets or touch screen displays, keyboards, mice, speakers, microphones, cameras (e.g., a front and/or a rear facing camera on a mobile device), and/or other hardware used to input data or output data. Storage 114 represents nonvolatile storage such as magnetic, optical, or other storage media included in device 101. In some embodiments, I/O components 112 may comprise VR controllers or AR input devices. In other embodiments, I/O components may comprise a controller or input device in a transportation device, such as a car, or boat. In yet other embodiments, the controllers or input devices may be the user's hands, and sensors 108 may be able to detect the movements and gestures in free space.

Audio/visual output device(s) 122 comprise one or more devices configured to receive signals from processor(s) 102 and provide audio or visual output to the user. For example, in some embodiments, audio/visual output device(s) 122 may comprise a display such as a touch-screen display, LCD display, plasma display, CRT display, projection display, or some other display known in the art. For use in augmented or virtual reality, audio/visual output device 122 may comprise a headset comprising a display for each eye, a mobile device, e.g., a mobile phone or tablet, a windshield of a vehicle, or some other display known in the art. Further, audio/visual output devices may comprise one or more speakers configured to output audio to a user.

System 100 further includes a touch surface 116, which, in this example, is integrated into computing device 101. Touch surface 116 represents any surface that is configured to sense touch interaction of a user. In some embodiments, touch surface 116 may be configured to detect additional information associated with the touch interaction, e.g., the pressure, speed of movement, acceleration of movement, temperature of the user's skin, or some other information associated with the touch input. One or more sensors 108 may be configured to detect a touch in a touch area when an object contacts a touch surface 116 and provide appropriate data for use by processor 102. Any suitable number, type, or arrangement of sensors can be used. For example, resistive and/or capacitive sensors may be embedded in touch surface 116 and used to determine the location of a touch and other information, such as pressure. As another example, optical sensors with a view of the touch surface 116 may be used to determine the touch position.

Further, in some embodiments, touch surface 116 and/or sensor(s) 108 may comprise a sensor that detects user interaction without relying on a touch sensor. For example, in one embodiment, the sensor 108 may comprise a proximity sensor that detects the presence of an object, such as a user's finger or a stylus, without any physical interaction between the user and the touch surface 116 or any other surface of the computing device 101. In still other embodiments, the sensor 108 may comprise a sensor configured to use electromyography (EMG) signals to detect pressure applied by a user on a surface. Further, in some embodiments, the sensor 108 may comprise RGB or thermal cameras and use images captured by these cameras to estimate an amount of pressure the user is exerting on a surface.

In some embodiments, sensor 108 and touch surface 116 may comprise a touch-screen display or a touch-pad. For example, in some embodiments, touch surface 116 and sensor 108 may comprise a touch-screen mounted overtop of a display configured to receive a display signal and output an image to the user. In other embodiments, the sensor 108 may comprise an LED detector. For example, in one embodiment, touch surface 116 may comprise an LED finger detector mounted on the side of a display. In some embodiments, the processor is in communication with a single sensor 108, in other embodiments, the processor is in communication with a plurality of sensors 108, for example, a first sensor and a second sensor.

In some embodiments, one or more sensor(s) 108 further comprise one or more sensors configured to detect movement of the computing device 101 (e.g., accelerometers, gyroscopes, cameras, GPS, or other sensors). These sensors 108 may be configured to detect user interaction that moves the device in the X, Y, or Z plane. The sensor 108 is configured to detect user interaction, and based on the user interaction, transmit signals to processor 102. In some embodiments, sensor 108 may be configured to detect multiple aspects of the user interaction. For example, sensor 108 may detect the speed and pressure of a user interaction, and incorporate this information into the interface signal. Further, in some embodiments, the user interaction comprises a multi-dimensional user interaction away from the device. For example, in some embodiments a camera associated with the device may be configured to detect user movements, e.g., hand, finger, body, head, eye, or feet motions, or interactions with another person or object.

In some embodiments, the sensors 108 are configured to detect a haptic output device 118 and provide appropriate data for use by processor 102. Any suitable number, type, or arrangement of sensors can be used. For example, different embodiments may include cameras, lasers, radars, accelerometers, gyrometers, pressure sensors, magnetic sensors, light sensors, microphones, capacitive sensors, touch sensors, tracking sensors, or any combination of such sensors. In one embodiment, a camera, laser mapping, or radar scanning is used to identify the haptic output device 118. Such an embodiment may utilize artificial intelligence (“AI”) to make the identification. An accelerometer may be used to detect vibration, displacement, and speed. A gyrometer may be used to sense rotation. A pressure sensor may be used to determine altitude and a magnetic sensor to determine direction or orientation. A light sensor may be used to determine perceived luminosity. And a microphone may be used to detect sound. Any of these sensors may be used in combination with any other sensor.

In this example, a haptic output device 118 in communication with processor 102 is coupled to touch surface 116. The haptic output device 118 may be configured to provide kinesthetic haptic feedback to the touch surface 116 by changing the stiffness of the touch surface 116. This may be done by particle jamming. While the kinesthetic haptic feedback is discussed with respect to the touch surface 116, the kinesthetic haptic feedback may be provided on any suitable surface or to any suitable device the user interacts with.

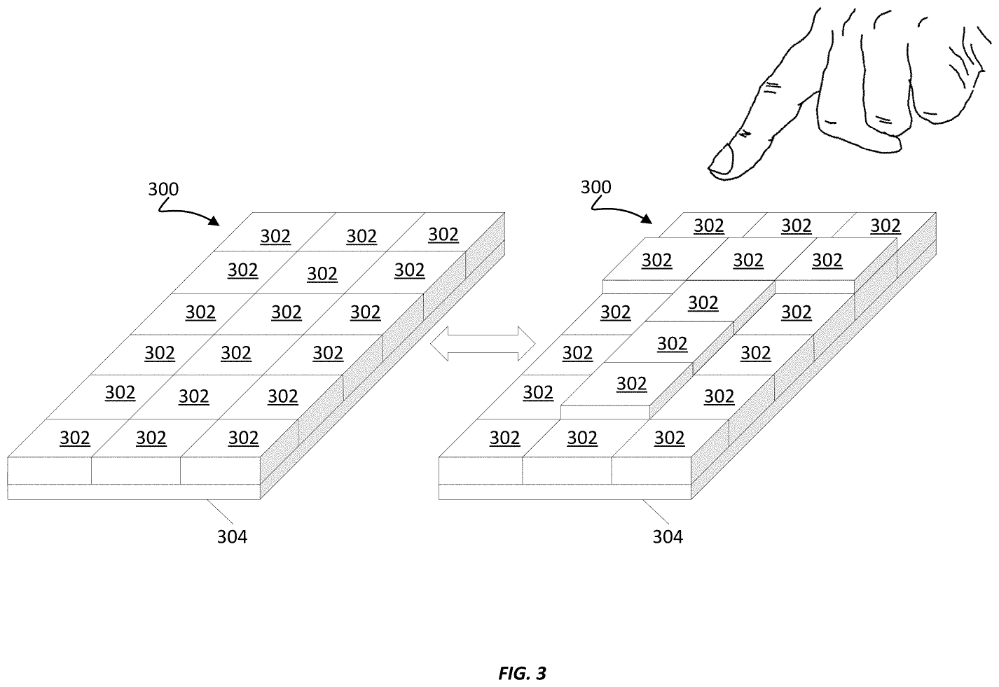

FIG. 1B shows an exemplary embodiment of the haptic output device 118. The haptic output device 118 may include at least one cell at least partially constructed from a flexible material filled with particles and a gas or fluid, which will be discussed below in reference to FIG. 3. The haptic output device 118 may provide kinesthetic haptic feedback using a first actuator 130 and a valve 134. The first actuator 130 may be a pneumatic pump, a vacuum pump, or any other suitable device for changing the pressure and/or the amount of gas or fluid inside at least one cell. By changing the pressure inside at least one cell, the particle to particle interaction changes, which changes the feedback provided by the haptic output device 118. For example, when the first actuator 130 is activated to change the pressure and create a vacuum in at least one cell, the particles are forced together, or “jammed,” so that the particles can no longer move, or can only move an inconsequential amount, relative to one another. As a result of the pressure change, at least one cell becomes a stiff structure and can be said to be in a “hard” state. In some embodiments, at least one cell may start as a stiff structure with the first actuator 130 activated to create a vacuum, and the first actuator 130 may be deactivated so that the pressure inside at least one cell changes the cell to be a soft structure, i.e., changes the cell to be in a “soft” state.

In some embodiments, the valve 134 is used to control the pressure inside at least one cell. For example, after the first actuator 130 changes the pressure in at least one cell, the valve 134 may maintain that changed pressure for a period of time, e.g., 1 millisecond, 1 second, 10 seconds, 30 seconds, 1 minute, etc. In other embodiments, the valve 134 may be used to transition at least one cell from the hard state to the soft state by allowing air, or any other suitable fluid or gas, to move back into the cell.

In addition to using the valve 134 to transition at least one cell from the hard state to the soft state, a second actuator 132 may be used to accelerate the transition. The second actuator 132 may be a pneumatic pump, a vacuum pump, an air compressor, or any other suitable device that can be used to move a gas or a fluid into at least one cell. In some embodiments, the second actuator 132 may be used to transition at least one cell from the soft state to the hard state when the first actuator 130 cause at least one cell to change from the hard state to the soft state.

In some embodiments, haptic output device 118 is configured, in response to a haptic signal, to output a haptic effect associated with the touch surface 116. Additionally or alternatively, haptic output device 118 may incorporate additional actuators to provide vibrotactile haptic effects that move the touch surface in a controlled manner to supplement the kinesthetic feedback. Some haptic effects may utilize an actuator coupled to a housing of the device, and some haptic effects may use multiple actuators in sequence and/or in concert. For example, in some embodiments, a surface texture may be simulated by adjusting the pressure of at least one cell located at the surface as described above, by vibrating the surface at different frequencies, or a combination of both adjusting the pressure and vibrating the surface. In such an embodiment, haptic output device 118 may comprise one or more of, for example, a vacuum pump, a pneumatic pump, a linear resonant actuator (LRA), a piezoelectric actuator, an eccentric rotating mass motor (ERM), an electric motor, an electro-magnetic actuator, a voice coil, a shape memory alloy, an electro-active polymer, or a solenoid.

Although a single haptic output device 118 is shown here, embodiments may use multiple haptic output devices 118 of the same or different type to output haptic effects. For example, haptic output device 118 may comprise one or more of, for example, a vacuum pump, a pneumatic pump, a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA), a low profile haptic actuator, a haptic tape, or a haptic output device configured to output an electrostatic effect, such as an Electrostatic Friction (ESF) actuator. In some embodiments, haptic output device 118 may comprise a plurality of actuators in a single haptic output device 118, for example a vacuum pump and an ERM or a pneumatic pump and an LRA. Further, haptic output device 118 may be integrated into a proxy object or into the user's clothing or a wearable device.

In some embodiments, the haptic effect may be modulated based on other sensed information about user interaction, e.g., relative position of hands in a virtual environment, object position in a VR/AR environment, object deformation, relative object interaction in a GUI, UI, AR, VR, etc. In still other embodiments, methods to create the haptic effects include the variation of an effect of short duration where the magnitude of the effect varies as a function of a sensed signal value (e.g., a signal value associated with user interaction). In some embodiments, when the frequency of the effect can be varied, a fixed perceived magnitude can be selected and the frequency of the effect can be varied as a function of the sensed signal value.

Computing device 101 may also comprise one or more of sensors 120. Sensors 120 may be coupled to processor 102 and used to monitor various properties of the haptic output device 118, including, but not limited to, the position, mass, voltage, back electromotive force or current of haptic output device 118. In some embodiments, sensors 120 may comprise a hall sensor, a magnetic field sensor, an accelerometer, a gyroscope, or an optical sensor. In other embodiments, sensor 120 may be embedded in haptic output device 118.

Turning to memory 104, exemplary program components 124, 126, and 128 are depicted to illustrate how a device may be configured to determine and output haptic effects. In this example, a detection module 124 configures processor 102 to monitor sensor(s) 108 or touch surface 116 via sensor 108 to determine characteristics of haptic output device 118. For example, detection module 124 may sample sensor 108 in order to track one or more of the location, path, velocity, acceleration, pressure, and/or other characteristics of haptic output device 118, an object, or an extremity of the user over time. In some embodiments, the detection module 124 configures processor 102 to monitor input devices to determine and then output haptic effects based on user input.

Haptic effect determination module 126 represents a program component that analyzes data received from the touch surface 116, the I/O components 112, the processor 102, and the sensors 108 to select a haptic effect to generate. Particularly, haptic effect determination module 126 comprises code that determines, based on the data, an appropriate type of haptic effect to output.

Haptic effect generation module 128 represents programming that causes processor 102 to generate and transmit a haptic signal to haptic output device 118, which causes haptic output device 118 to generate the selected haptic effect. For example, generation module 128 may access stored waveforms or commands to send to haptic output device 118. As another example, haptic effect generation module 128 may receive a desired type of haptic effect and utilize signal processing algorithms to generate an appropriate signal to send to haptic output device 118. As a further example, a desired haptic effect may be indicated along with target coordinates for the texture and an appropriate waveform sent to one or more actuators to generate appropriate displacement or pressure change of the surface (and/or other device components) to provide the haptic effect. Some embodiments may utilize multiple haptic output devices in concert to simulate a feature. For example, a vibration may be utilized to convey a specific texture to the user while, simultaneously, a kinesthetic effect is output to indicate the stiffness of an object, such as the stiffness of a shoe upper's material. In some embodiments, processor 102 may stream or transmit the haptic signal to the haptic output device 118. Such a configuration is merely illustrative and not the sole way in which such a system may be constructed.

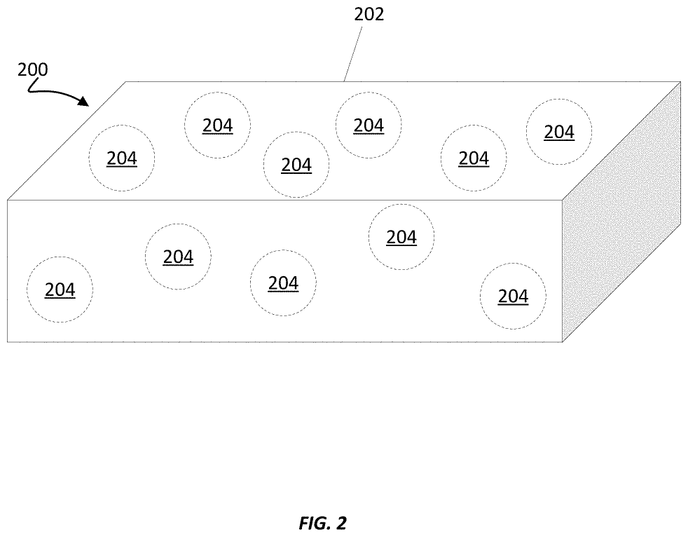

FIG. 2 shows another illustrative system for providing haptic feedback using particle jamming. In the embodiment shown in FIG. 2, a single, exemplary cell 200 is shown. The cell 200 is formed by an outer material 202, which encloses particles 204 and a gas or fluid, e.g., air, water, etc., in the interior of the cell 200. In some embodiments, the outer material 202 may be an elastomer, a rubber material, a silicone-based material, or any other suitable, flexible material that is able to change shape and adjust to changes in pressure of the interior of the cell 200. In some embodiments, the particles 204 may be micro-plastic beads, ground coffee, or any other suitable fine particle. Additionally, the outer material 202 and the particles 204 may be made from a material that is substantially transparent or translucent. This enables the cell 200 to be incorporated into a display screen without obstructing the visual output of the screen.

While the cell 200 is shown as rectangular shaped, the cell may take any suitable shape including cylindrical, spherical, trapezoidal, pyramidal, etc. Additionally, the cell 200 may be completely enclosed by the outer material 202 or the cell 200 may be only partially enclosed by the outer material 202. For example, the cell 200 may be a cavity in a device, such as gaming controller, a smart watch, computer, etc., so that the outer material 202 covers an opening of the cavity thereby enclosing the cell 200.

FIG. 3 shows another illustrative system for providing haptic feedback using particle jamming. In the embodiment shown in FIG. 3, a mobile device 300 is shown. The illustrative system of FIG. 3 may incorporate the system illustrated in FIG. 1 for providing haptic feedback using particle jamming. The mobile device 300 incorporates a plurality of cells 302, the cells 302 being the same as those described above in reference to FIG. 2, and a housing 304 that contains the computing device 101 described above in reference to FIG. 1A and the first actuator 130, second actuator 132, and the valve 134 described above in reference to FIG. 1B. The mobile device 300 may also incorporate a visual display. The visual display may be disposed on the surface of the plurality of cells 302, a portion of the surface of the plurality of cells 302, the housing 304, or any other suitable location on the mobile device 300.

In some embodiments, each individual cell 302 may be coupled to a dedicated first actuator 130, second actuator 132, and valve 134 to change and control the pressure of that individual cell 302. In other embodiments, a grouping of cells 302 may be coupled to the same first actuator 130, second actuator 132, and valve 134 so that the pressure of the group of cells 302 may be changed and controlled by the same devices.

In some embodiments, the mobile device 300 may be in a soft state, where the particles in the cells 302 may move relative to one another inside the cells 302. When the mobile device 300 is in this soft state, the mobile device 300 is able to flex and bend. When the mobile device 300 receives a phone call, a text message, an e-mail, or some other similar action, the first actuators 130 may be activated to change the pressure inside the cells 302 to create a vacuum in each of the cells 302. As a result, the mobile device 300 changes to be in a hard state where each of the cells 302 has a stiff structure due to the particles in the cells 302 not being able to move relative to one another. In other embodiments, specific first actuators 130 may be activated to change the pressure inside the cells 302 associated with those first actuators 130 so that a pattern is created in the cells 302. For example, when the mobile device 300 receives a text message, the stiffened cells 302 may form a letter “T,” as shown in FIG. 3.

In other embodiments, the mobile device 300 includes a proximity sensor 108 that detects objects near the mobile device 300. The mobile device 300 may utilize data received from the proximity sensor 108 in order to output kinesthetic feedback. For example, a user may be using the mobile device 300 when a button appears on the display of the mobile device 300 that the user needs to select. As the user moves a finger or a stylus near the button, the first actuators 103 associated with the cells 302 in the area where the button appears may change the pressure in those cells 302 before the user contacts the display or touch surface so that the user feels the stiffened cells 302 when selecting the button.

Increasing the number of cells 302 per feedback area means that the size of each cell 302 may be decreased. Decreasing the size of the cells 302 results in quicker changes to the pressure in the cells 302, which provides a faster kinesthetic feedback. Additionally, increasing the number of cells 302 per feedback area allows for greater control over the shapes or patterns that may be created to provide the kinesthetic feedback, which provides for a greater variety in the kinesthetic feedback generated.

In other embodiments, additional ways of providing haptic feedback using particle jamming may be used. In some embodiments, at least one cell may be filled with a smart fluid, such as a magnetorheological fluid, an electrorheological fluid, or a ferrofluid, where the application of an external stimulus such as a magnetic or electrical field changes the particle to particle interaction of the fluid and may result in the stiffening or softening of at least one cell. In other embodiments, the actuator may be used to release an additional material such as a chemical agent into the gas or the fluid inside at least one cell that causes a chemical reaction to change the particle to particle interaction.

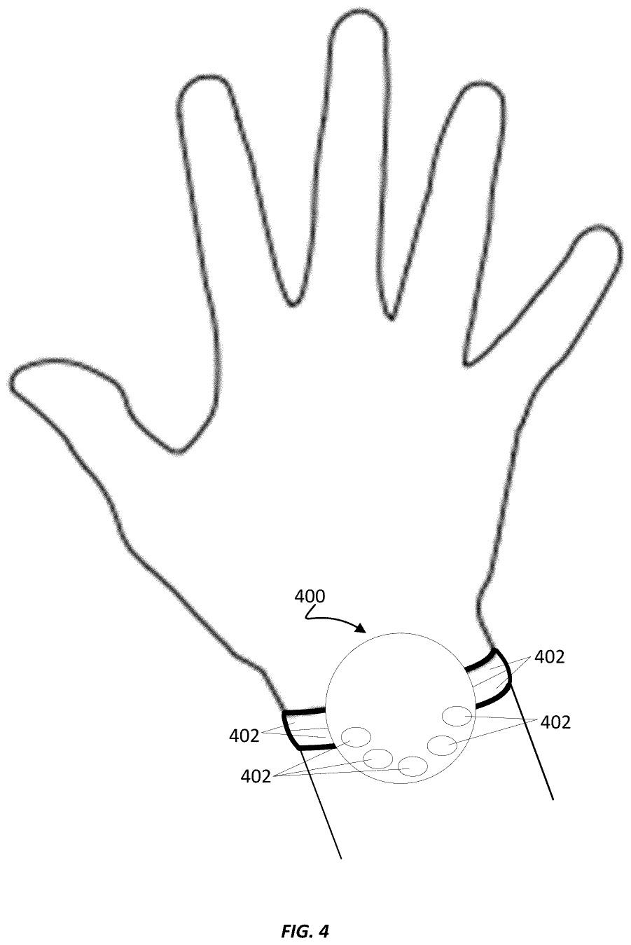

FIG. 4 shows another illustrative system for providing haptic feedback using particle jamming. In the embodiment shown in FIG. 4, a user is wearing wearable device 400, in the form of a smart watch. The illustrative system of FIG. 4 may incorporate the system illustrated in FIG. 1 for providing haptic feedback using particle jamming. Wearable device 400 may also include a glove that covers the user's whole hand, a glove that covers only some of the user's hand and fingers, e.g., only the user's thumb and index finger, pieces that only cover the user's fingertips, a shoe, a shirt, a pair of pants, or any other article of clothing.

The wearable device 400 incorporates a plurality of cells 402, where the cells 402 are the same as those described above in reference to FIG. 2, on both the wristband and the face of the wearable device 400. In some embodiments, the cells 402 may be located inside the wearable device 400. As discussed above, a first actuator 130 may be used to change the pressure of at least one of the cells 402 to provide a kinesthetic feedback to the user. In some embodiments the cells 402 may be on the outward facing side of the wearable device 400, to provide haptic feedback when the user touches the surface of wearable device 400. Alternatively or additionally, the cells 402 may be on the opposite side (the skin facing side) and output haptic effects that the user feels on the wearable surface of the wearable device 400. A valve 134 may be used to control and maintain the change in pressure and a second actuator 132 may be used to reverse the pressure change applied by the first actuator 130 so that the cell 402 returns to its original state.

### Illustrative Methods for Providing Haptic Feedback Using Particle Jamming

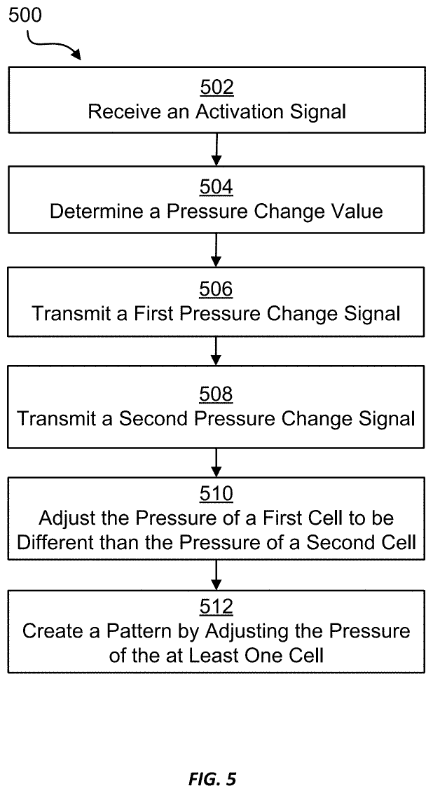

FIG. 5 is a flow chart of method steps for one example embodiment for providing haptic feedback using particle jamming. In some embodiments, the steps in FIG. 5 may be implemented in program code that is executed by a processor, for example, the processor in a general purpose computer, a mobile device, virtual reality or augmented reality control system, or a server. In some embodiments, these steps may be implemented by a group of processors. In some embodiments one or more steps shown in FIG. 5 may be omitted or performed in a different order. Similarly, in some embodiments, additional steps not shown in FIG. 5 may also be performed. The steps below are described with reference to components described above with regard to computing device 101 shown in FIG. 1 and the system shown in FIGS. 3 and 4.

In the embodiment shown, a process 500 begins at step 502 when a processor, such as processor 102, receives an activation signal. The processor 102 may receive the activation signal from one or more sensors 108, I/O components 112, or audio/visual output devices 122. For example, the sensor 108 may be a proximity sensor that detects an object near the computing device 101 or a pressure sensor that detects a touch to the touch screen 116.

At step 504 the processor 102 next determines a pressure change value for at least one cell based in part on the activation signal received at step 502. For example, the processor 102 may determine that the pressure in at least one cell needs to change so that the cell transitions from a soft state to a hard or stiff state, or vice versa based on an object moving towards or away from the computing device 101.

At step 506 the processor 102 transmits a first pressure change signal based in part on the pressure change value to the first actuator 130. Transmitting the first pressure change signal will cause the first actuator 130 to alter a stiffness of at least one cell by adjusting the pressure of at least one cell. For example, the first actuator 130 may be activated to remove substantially all of the fluid or gas that fills at least one cell so that the particles disposed in at least one cell cannot move relative to one another.

At step 508 the processor 102 transmits a second pressure change signal based in part on the pressure change value to the valve 134. Transmitting the second pressure change signal will cause the valve to alter the stiffness of at least one cell by adjusting the pressure of at least one cell. For example, the valve may be opened so that the fluid or gas that was removed from at least one cell may flow back into at least one cell to transition at least one cell from a hard state to a soft state. Additionally, the second pressure change signal may cause the valve to maintain the pressure in at least one cell at the level that the first actuator 130 changed the pressure to.

At step 510 the processor 102 adjusts the pressure of a first cell to be different than the pressure of a second cell. The processor 102 may determine multiple different pressure change values at step 502, e.g., a first pressure change value and a second pressure change value. The processor 102 may then transmit multiple first pressure change signals to multiple first actuators 130 based on these different pressure change values at step 506. For example, the first pressure change signal based on the first pressure change value may be transmitted to the first actuator 130 that controls the first cell to alter the stiffness of the first cell. The first pressure change signal based on the second pressure change value may be transmitted to the first actuator 130 that controls the second cell to alter the stiffness of the second cell, where the stiffness of the second cell is different from the stiffness of the first cell.

At step 512 the processor 102 creates a pattern by adjusting the pressure of at least one cell. By adjusting the pressure of a first cell to be different than the pressure of a second cell at step 510, the processor 102 may create various patterns and kinesthetic feedback for a haptic feedback device. For example, the processor 102 may create letters, numbers, symbols, etc. by changing the pressure, and thus the stiffness, of the various cells that make up the haptic feedback device.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A system for providing haptic feedback comprising:
at least one cell;
a plurality of particles disposed in the at least one cell;
a first actuator configured to change a pressure of the at least one cell;
a valve configured to control the pressure of the at least one cell; and
a processor communicatively coupled to the first actuator and the valve, the processor configured to:
receive an activation signal;
determine a pressure change value for the at least one cell based in part on the activation signal;
transmit a first pressure change signal to the first actuator to cause the first actuator to alter a stiffness of the at least one cell based in part on the pressure change value; and
transmit a second pressure change signal to the valve to cause the valve to alter the stiffness of the at least one cell based on the pressure change value.

2. The system of claim 1, further comprising a second actuator configured to reverse the change in pressure of the at least one cell applied by the first actuator.

3. The system of claim 1, wherein the at least one cell comprises a plurality of cells.

4. The system of claim 1, wherein the plurality of particles comprises at least one of micro-plastic particles or ground coffee.

5. The system of claim 1, wherein the at least one cell comprises at least one of an elastomer, a rubber material, or a silicone-based material.

6. The system of claim 1, wherein the system further comprises a proximity sensor.

7. The system of claim 6, wherein the processor is configured to determine the pressure change value based in part on data received from the proximity sensor.

8. The system of claim 1, wherein the processor is configured to determine the pressure change value based on a user interaction.

9. The system of claim 1, further comprising a wearable device and wherein the cell, the first actuator, the valve, and the processor are mechanically coupled to the wearable device.

10. A method for providing haptic feedback comprising:
receiving an activation signal;
determining, based in part on the activation signal, a pressure change value for at least one cell comprising a plurality of particles disposed in the at least one cell;
transmitting a first pressure change signal to a first actuator to cause the first actuator to alter a stiffness of the at least one cell based in part on the pressure change value; and
transmitting a second pressure change signal to a valve to cause the valve to alter the stiffness of the at least one cell based on the pressure change value.

11. The method of claim 10, further comprising adjusting the pressure of a first cell to be different than the pressure of a second cell.

12. The method of claim 11, further comprising creating a pattern by adjusting the pressure of the at least one cell.

13. The method of claim 10, wherein determining the pressure change value for at least one cell comprises determining the pressure change value based in part on data received from a proximity sensor.

14. The method of claim 10, wherein determining the pressure change value for the at least one cell comprises determining the pressure change value based on a user interaction.

15. The method of claim 10, wherein a second actuator is used to reverse the change in pressure of the at least one cell applied by the first actuator.

16. The method of claim 10, wherein the at least one cell comprises a plurality of cells.

17. The method of claim 10, wherein the plurality of particles comprises at least one of micro-plastic particles or ground coffee.

18. The method of claim 10, wherein the at least one cell comprises at least one of an elastomer, a rubber material, or a silicone-based material.

19. The method of claim 10, wherein the at least one cell, the first actuator, and the valve are mechanically coupled to a wearable device.

20. A non-transitory computer readable medium comprising program code, which when executed by a processor is configured to cause the processor to:
receive an activation signal;
determine, based in part on the activation signal, a pressure change value for at least one cell comprising a plurality of particles disposed in the at least one cell;
transmit a first pressure change signal to a first actuator to cause the first actuator to alter a stiffness of the at least one cell based in part on the pressure change value; and
transmit a second pressure change signal to a valve to cause the valve to alter the stiffness of the at least one cell based on the pressure change value.
